(19) United States
(12) Patent Application Publication
(10) Pub. No.: US 2016/0200133 A1
(43) Pub. Date: Jul. 14, 2016

(54) SECURITY ELEMENT, PARTICULARLY A SECURITY LABEL

(71) Applicant: HUECK FOLIEN GES.M.B.H., Baumgartenberg (AT)

(72) Inventors: Georg AIGNER, Pabneukirchen (AT); Marco MAYRHOFER, Sierning (AT)

(21) Appl. No.: 14/900,323

(22) PCT Filed: Jun. 13, 2014
(86) PCT No.: PCT/EP2014/001612

§ 371 Date: Feb. 16, 2016

(30) Foreign Application Priority Data
Sep. 20, 2013 (EP) 13004600.6

(51) Int. Cl. B42D 25/373; D21H 21/48; B42D 25/337

(52) U.S. Cl. CPC B42D 25/373; B42D 25/337; D21H 21/48

(57) ABSTRACT

The invention relates to a security element, particularly for security labels, having a carrier substrate (1) which has on one surface a colour-shift effect structure consisting of a layer of metal clusters (2), a spacer layer (3) and a layer (6) that reflects electromagnetic waves, characterized in that the spacer layer (3) consists of two sub-layers (4, 5) of identical or different composition situated one on top of the other, wherein the first sub-layer (4) facing toward the cluster layer (2) exhibits greater adhesion to the cluster layer than to the second sub-layer (5), and the second sub-layer (5) facing toward the layer (6) that reflects electromagnetic waves exhibits greater adhesion to the layer (6) that reflects electromagnetic waves than to the first sub-layer (4).

The invention relates to a security element, in particular in the form of a security label, which exhibits at least one color-shift effect which becomes irreversibly altered or destroyed after any attempt at tampering.

EP 1 716 007 B1 discloses a security element that prevents counterfeiting, composed of respectively at least one layer reflecting electromagnetic waves, one polymeric spacer layer, and a layer formed from metallic clusters, where one or more of the layers has/have other security functions in addition to the function thereof in the setup producing the color-shift effect.

These security elements are either applied to a supportive substrate or by way of example in the case of papermaking for security papers are embedded at least to some extent into the paper.

EP 1 972 674 A discloses a security label or a security adhesive tape which provides evidence of tampering and which has a flexible supportive substrate based on a flexible plastics foil, with partial application, to the supportive substrate, of a release coating in the form of letters, signs, symbols, lines, guilloche patterns, numerals, or writing, and then, covering the entire surface, application of a colored or transparent coating or metallization and, onto this layer covering the entire surface, application of a transparent or colored release layer covering the entire surface and application of a self-adhesive coating on this release layer.

It was an object of the present invention to provide a security element, and in particular a security label, which when intact exhibits at least one color-shift effect which, however, becomes irreversibly altered or destroyed in the event of any attempt at tampering.

The invention therefore provides a security element in particular for security labels, having a supportive substrate (1) which on one surface has an assembly producing a color-shift effect, composed of a layer made of metallic clusters (2), of a spacer layer (3), and of a layer (6) reflecting electromagnetic waves, characterized in that the spacer layer (3) is composed of two sublayers (4, 5) of identical or different composition situated on top of one another, where the first sublayer (4), facing toward the cluster layer (2), has greater adhesion to the cluster layer than to the second sublayer (5), and the second sublayer (5), facing toward the layer (6) reflecting electromagnetic waves, has greater adhesion to the layer (6) reflecting electromagnetic waves than to the first sublayer (4).

Examples of supportive substrate that can be used are supportive foils, preferably flexible plastics foils, for example made of PI, PP, MOPP, PE, PPS, PEEK, PEK, PEI, PSU, PAEK, LCP, PEN, PBT, PET, PA, PC, COC, POM, ABS, PVC, fluoropolymers, for example Teflon and the like. The thickness of the supportive foils is preferably from 5 to 700 μm, with preference from 5 to 200 μm, with particular preference from 12 to 100 μm.

Applied on one surface of the supportive substrate there is a layer sequence which produces a color-shift effect. The perceived color here changes with the angle of observation, for example from magenta to green or from green to blue.

Applied to the supportive substrate here there can firstly optionally be a partial release-lacquer coating. Materials that can in particular be used as release-lacquer coating are known lacquer compositions having low adhesion, based by way of example on cycloolefin copolymers, on nitrocellulose, on acrylates, on polyvinyl chloride, on ethylene-acrylate copolymers, or on styrene acrylates in a suitable solvent. It is preferable here that chlorinated polyolefins are added to adjust the adhesion. The proportion of the chlorinated polyolefins in the composition can be from 20 to 130% by weight relative to the base polymer. It is moreover also possible to use very thin applications of polyamide layers, polyethylene layers, fluoropolymer wax layers, or silicone coatings, at a thickness of about 20-300 nm.

Applied on this first surface of the supportive substrate, or on the partial release-lacquer coating, there is a layer made of metallic clusters. Application of this layer made of metallic clusters can cover the entire surface or can be partial. The metallic clusters can by way of example be composed of aluminum, gold, palladium, platinum, chromium, silver, copper, nickel, tantalum, titanium, tin, zinc, molybdenum, and the like, or of alloys of these, for example Au/Pd, Cu/Ni, or Cr/Ni.

It is also preferably possible to apply cluster materials, for example semiconductor elements of main group III to VI or of transition group II of the periodic table of the elements, where Plasmon excitation of these can be triggered externally (e.g. by way of X-rays or ion beams, or electromagnetic interactions). Observation using a suitable reader device can thus detect a visible change in the color spectrum (e.g. intensity change) and/or a change due to the color-shift effect.

The cluster layer can also have additional properties, for example electrically conductive, magnetic or fluorescent properties: by way of example, a cluster layer made of Ni, Cr/Ni, Fe and/or core-shell structures using these materials and/or mixtures of these materials, using the abovementioned cluster materials, exhibits such additional features. It is also possible to produce fluorescent clusters inter alia via core-shell structures, e.g. with use of Quantum Dots® from Quantum Dot Corp.

When the cluster layer is produced in vacuum processes it is advantageously possible to influence the growth of the clusters, and with this their shape, and also the optical properties, via adjustment of the surface energy or of the roughness of the layer located there-under. This alters the spectra in characteristic fashion. This can be achieved by way of example via heat treatment in the coating process or via preheating of the substrate.

These parameters can moreover by way of example be altered in controlled manner by treating the surface with oxidizing liquids, for example with Na hypochlorite, or in a PVD or CVD process.

The cluster layer can preferably be applied by means of sputtering.

Adjustment of the properties of the layer here, in particular of the density and the structure, is achieved primarily via the power density, the quantity of gas used and the composition of said quantity, the temperature of the substrate, and the web velocity.

Application by means of processes using printing technology is achieved by, after any necessary procedure to concentrate the clusters, admixing, to the solution, small quantities of an inert polymer, for example PVA, polymethyl methacrylate, nitrocellulose systems, polyester systems, or urethane systems. The mixture can then be applied by means of a printing process, for example screen-printing, flexographic printing or preferably intaglio printing processes, by means of a coating process, for example lacquering, spray-application, roll-application methods, and the like. Metal clusters of this type are termed colloidal metal clusters because, prior to application, they are present in a colloidal solution in the lacquer system or in solvent.

The thickness of the cluster layer is preferably from 2 to 20 nm, particularly preferably from 3 to 10 nm.

Applied on the cluster layer, there is then a spacer layer that is in essence transparent.

This spacer layer is composed in the invention of two sublayers arranged on top of one another. The sublayers can be composed of inorganic materials, for example metal oxides, metal sulfides, metal fluorides, or metal nitrides, for example silicon oxide, zinc sulfide, copper oxide, titanium oxide, zirconium oxide, magnesium fluoride, and the like, or of organic polymers, for example cycloolefin copolymers, for example Topas® 6013, Topas® 6015, Topas® 6017, Topas® 5013 from Ticona, nitrocellulose, for example E400 from Wolff Walsrode, acrylates, methacrylates, polyvinyl chloride polymers, for example Vinnol E15/45M, H 30/48M, or E 22/48A from Wacker Chemie AG, ethylene-acrylate copolymers, or styrene acrylates, for example from the Acronal line of BASF AG, Acronal® 280D, 12DE, 1051, 7104, or of epoxies or polyurethanes.

The inorganic sublayers are preferably applied in a known PVD or CVD process.

The polymeric sublayers are usually applied by means of processes involving print, rolls, nozzles, sprays, immersion, or lacquering, or by a combination of these processes.

The first sublayer, facing toward the cluster layer, of the spacer layer here is a layer having good adhesion on the cluster layer. The adhesion of the first sublayer of the spacer layer to the cluster layer here can optionally be improved by corona treatment, flame treatment, or plasma treatment.

This first sublayer can, over the entire surface or partially, take the form by way of example of positive or negative letters, numerals, symbols, signs, lines, guilloche patterns, or the like.

Applied on this first sublayer of the spacer layer there is the second sublayer of the spacer layer.

The adhesion of the second sublayer to the subsequent layer reflecting electromagnetic waves is better than to the first sublayer.

The second sublayer can, over the entire surface or partially, take the form by way of example of positive or negative letters, numerals, symbols, signs, lines, guilloche patterns, or the like.

If the two sublayers have identical or similar composition, the adhesion between the two sublayers can be influenced via suitable surface functionalization of that surface of the first sublayer that faces toward the second sublayer. Examples of suitable surface-functionalization measures are corona treatment, flame treatment, plasma treatment, print pretreatment, chemical pretreatment, acid treatment, UV irradiation, ozonization, and the like. The adhesion of a polymeric second sublayer can moreover be adjusted by adding chlorinated polyolefins. The proportion of the chlorinated polyolefins in the composition can be from 20 to 130% by weight relative to the base polymer.

The two sublayers can have an identical or different refractive index, depending on composition.

The thickness of the spacer layer composed of two sublayers here can be varied in controlled manner within a wide range, for example in the range of about 10 nm up to 4 μm. The two sublayers of the spacer layer here can have identical or different thickness, their respective thickness being about 10 nm up to 2 μm.

The two sublayers can be colorless and transparent. At least one of the sublayers can also have a coloring, and in this case the color shade of the two sublayers is preferably different.

A color shade is produced in an organic layer by adding dyes or pigments to the corresponding polymer, suitable dyes or pigments used here being any of those that are commercially available, for example inorganically based pigments, for example titanium dioxide, zinc sulfide, kaolin, ATO, FTO, aluminum, chromium oxides, and silicon oxides, or organically based pigments, for example phthalocyanine blue, isoindolidine yellow, dioxazine violet, and the like, and also colored and/or encapsulated pigments. Examples of dyes that can be used are 1,1- or 1,2-chromium-cobalt complexes. The pigments or dyes used here are not permitted to have any substantial effect on the transparency of the layers, in order that the interference effect in the spacer layer is not suppressed. The coloring of the spacer layer and the color-shift effect are mutually superimposed, thus leading to altered color perceptions at different observation angles.

Sublayers made of inorganic materials are either colorless and transparent or have an intrinsic color.

Applied on the second sublayer there is then a layer reflecting electromagnetic waves: the reflective layer or reflection layer. This layer can preferably be composed of metals, for example aluminum, gold, chromium, silver, copper, titanium, tin, platinum, nickel, molybdenum, or tantalum, of semiconductors, for example silicon, or of alloys of these, for example nickel/chromium, or copper/aluminum, or the like, or of a printing ink with metal pigments, or else of metal oxides, metal sulfides, metal nitrides, or metal fluorides.

The layer reflecting electromagnetic waves is applied over the entire surface or partially by known processes, for example spraying, deposition from vapor, sputtering, PVD processes or CVD processes, or by way of example in the form of printing ink by known printing processes (intaglio printing, flexographic printing, screen printing, digital printing), by lacquering, by roll-application processes, by die-application processes, by immersion-application processes (roll dip coating), or by curtain-coating processes, and the like.

Both the layer reflecting electromagnetic waves and the cluster layer can be applied partially. If these are applied by means of PVD processes or CVD processes, the structuring is achieved by means of known etching or washing processes. A process of this type is disclosed by way of example in EP 1 291 463 A.

A protective covering layer which can optionally also have functional features can then be applied on the layer reflecting electromagnetic waves.

This protective covering layer serves optionally as barrier layer for an adhesive coating subsequently applied, in particular a self-adhesive coating or a heat-sealable or cold-sealable coating. At the same time the protective covering layer provides protection for the layer reflecting electromagnetic waves.

Applied on the second surface of the supportive substrate there can optionally be a print primer, intended to facilitate, or indeed permit, subsequent printing of the surface.

In another embodiment it is also possible to use a reversed mirror-image assembly of the color-shift-effect layers where, applied to the first surface of the supportive substrate, there is then firstly the layer reflecting electromagnetic waves, then the spacer layer composed of two sublayers, and on this then the cluster layer.

The security element of the invention can moreover have other visually discernible and/or machine-readable security features.

These layers can by way of example have certain magnetic, chemical, physical, and also optical properties.

The magnetic properties can be adjusted by using para-magnetic, diamagnetic, and also ferromagnetic substances, for example iron, nickel, and cobalt, or compounds or salts of these (for example oxides or sulfides).

The optical properties of the layer can be influenced via visible dyes or pigments, luminescent dyes or pigments which fluoresce or phosphoresce in the visible region, in the UV region, or in the IR region, special-effect pigments, for example liquid crystals, pearl luster, bronzes, and/or multilayer color-change pigments, and heat-sensitive colors or pigments. These can be used individually or in any of the possible combinations.

The security element of the invention can moreover have optically active features, for example diffraction gratings, diffraction structures, holograms, Kinegrams, and the like.

Electrical properties, for example conductivity, can be adjusted by way of example by adding graphite, carbon black, conductive organic or inorganic polymers, metal pigments (for example copper, aluminum, silver, gold, iron, chromium, and the like), metal alloys, for example copper-zinc or copper-aluminum, or else amorphous or crystalline ceramic pigments, for example ITO and the like.

The security element of the invention can have a self-adhesive coating, a heat-sealable coating, or a cold-sealable coating which can be used to fix the security element on an object requiring security.

FIGS. 1 to 5 depict embodiments of the security element of the invention.

### KEY TO FIGURES

1 the supportive substrate

2 the layer made of metallic clusters

3 the spacer layer

4 the first sublayer of the spacer layer

5 the second sublayer of the spacer layer

6 the layer reflecting electromagnetic waves

7 the protective covering layer

8 a self-adhesive layer

9 a print-compatible primer layer

10 a partial release-lacquer layer

11 adhesion-promoter layer

The security element depicted in FIG. 1 has a supportive substrate 1, for example made of PET. Applied on this supportive substrate 1 there is, on one surface, a print-compatible primer 9, and on the other surface a layer composed of metallic clusters 2, the cluster layer in this case being composed of Cr.

Applied on this layer made of metallic clusters there is the spacer layer 3, which is composed of two sublayers 4 and 5. The first sublayer 4 covering the entire surface has good adhesion to the cluster layer and is composed of a polyvinyl chloride polymer Vinnol 14/45H from Wacker; the second sublayer 5 likewise covers the entire surface and in this case is composed of E 400 nitrocellulose from Wolff Walsrode. The two sublayers are transparent and colorless.

Situated on this second sublayer there is a layer 6 reflecting electromagnetic waves, in this case a metallic layer made of Al. The adhesion between the second sublayer and the metallic Al layer is higher than the adhesion of the second sublayer to the first sublayer. In the present example the adhesion of the Al layer on the second sublayer has been additionally increased by means of a plasma pretreatment.

A protective covering layer 7, in particular a lacquer layer, and then a self-adhesive coating 8 which allows fixing of the assembly on an object requiring security have been provided to this layer reflecting electro-magnetic waves.

The assembly exhibits a color-shift effect from magenta to green.

If, after the label has been applied by adhesion, it is subject to tampering, i.e. an attempt is made to peel it from the object requiring security, the assembly separates between the two sublayers of the spacer layer.

This eliminates the color-shift effect over the entire surface because the interference effect in the spacer layer is disrupted. That part of the assembly that remains on the object requiring security exhibits a metallic luster, while the peeled part appears grayish and transparent.

If an attempt is made to reassembly the assembly, for example by use of pressure or by means of an adhesive coating, it is impossible to reinstate the color-shift effect, because it is impossible to reinstate the original thickness of the spacer layer. Either an air gap remains between the two sublayers or, if an adhesive layer is used between the two sublayers, the thickness of the spacer layer is altered to such an extent that it is no longer possible to reinstate the original color-shift effect.

FIG. 2 depicts another embodiment of the invention.

The security element of the invention here is composed of a supportive substrate 1 to which a primer 9 has been provided on one surface and which has, on the other surface, a partial release-lacquer layer 10 in the form of letters, numerals, symbols, signs, lines, guilloche patterns, or the like. A silicone coating forms the release-lacquer coating.

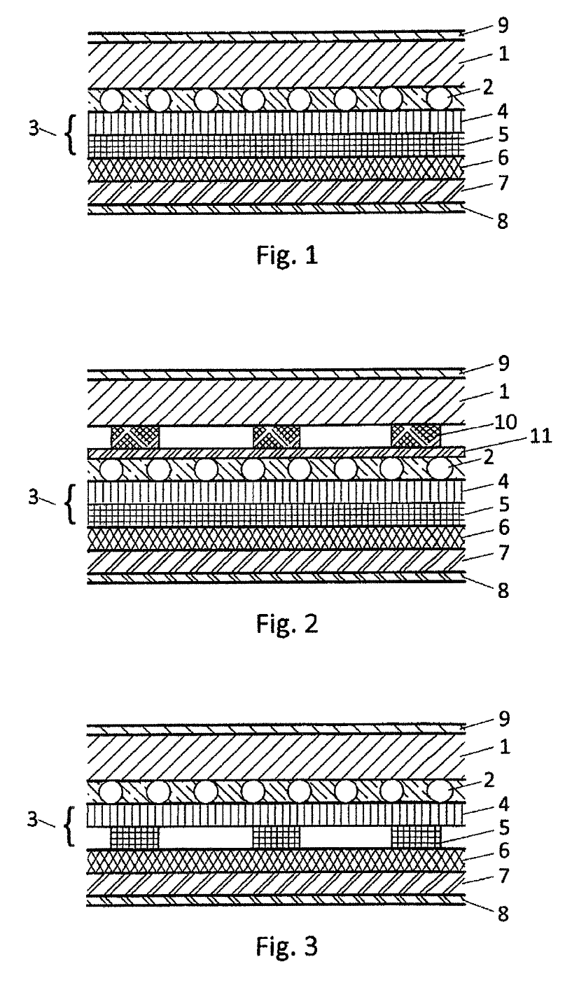

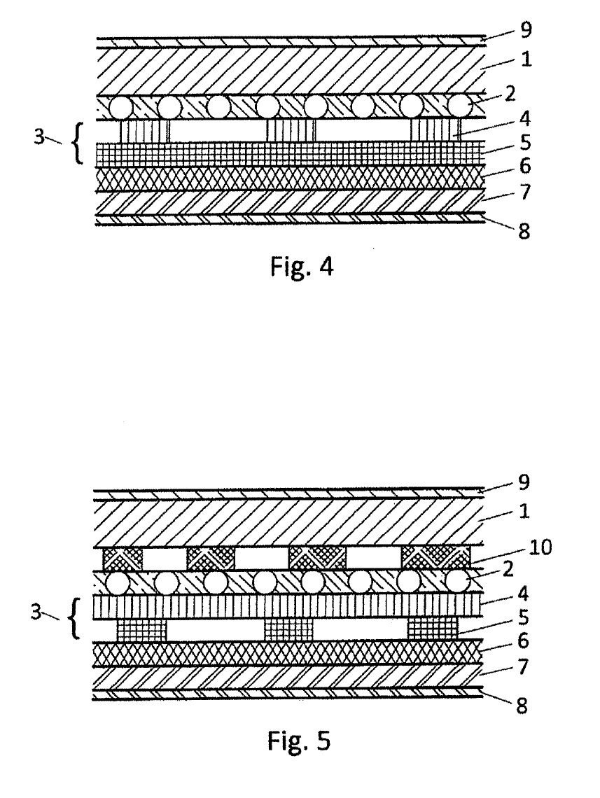

An adhesion-promoter layer 11 can then optionally have been applied in order to strengthen the adhesion of the subsequently applied layer made of metallic clusters 2. This adhesion-promoter layer is not absolutely essential, but when optical requirements are stringent it is advantageous because it sometimes provides a smoothing effect where the release-lacquer coating is uneven. The security element depicted in FIG. 2 then has a spacer layer 3 composed of a first sublayer 4 which is composed of silicon oxide and has good adhesion on the cluster layer, and of a second sublayer 5, which is composed of zinc sulfide and has poor adhesion to the first sublayer but good adhesion to the subsequent layer reflecting electromagnetic waves. In this example the two sublayers are transparent.

Applied on the spacer layer there is the metallic layer 6 reflecting electromagnetic waves, to which in turn a protective covering lacquer 7 and a self-adhesive coating 8 have been provided.

The adhesion ratios of the layers here have been adjusted in such a way that the adhesion of the release coating 10 on the supportive substrate 1 is poorer than that between the two sublayers 4, 5 of the spacer layer 3.

If, after the label has been applied by adhesion, it is subject to tampering, i.e. an attempt is made to peel it from the object requiring security, where the release-lacquer coating 10 is present the release-lacquer coating 10 separates from the supportive substrate 1 or from the cluster layer 2; where the release-lacquer coating 10 is not present the two sublayers 4 and 5 separate from one another. In the latter region the color-shift effect is eliminated; where the release-lacquer coating 10 is present the color-shift effect is retained because no separation of the sublayers 4, 5 of the spacer layer 3 occurs and the thickness of the spacer layer 3 is therefore not altered.

FIG. 3 depicts an assembly in which an attempt at tampering completely eliminates or destroys a first color-shift effect, but a second color-shift effect is retained.

The security element has a supportive substrate 1, for example a PET foil of thickness 50 μm.

Applied on this supportive substrate 1 there is on one surface a print-compatible primer 9, and on the other surface a layer composed of metallic clusters 2, the cluster layer in this case being composed of Ti.

Applied on this layer made of metallic clusters there is the spacer layer 3, composed of two sublayers 4 and 5. The first sublayer 4, covering the entire surface, has good adhesion to the cluster layer; the second sublayer 5 is partial, taking the form of signs, letters, numerals, symbols, lines, or guilloche patterns or other patterns, and has poor adhesion to the first sublayer 4 and excellent adhesion to the layer 6 reflecting electromagnetic waves, situated on the second sublayer 5 and in this case composed of Ni.

Provided to this layer 6 reflecting electromagnetic waves there is a protective covering layer 7 and then a self-adhesive coating 8 which can fix the assembly on an object requiring security.

The assembly exhibits a color-shift effect where the two sublayers 4 and 5 are present, from magenta to green, and exhibits another color-shift effect from green to blue where only the first sublayer 4, covering the entire surface, is present.

If, after the label has been applied by adhesion, it is subject to tampering, i.e. an attempt is made to peel it from the object requiring security, where the two sublayers 4 and 5 are present the assembly separates between the two sublayers of the spacer layer. In the other regions, where only the sublayer 4 is present, the adhesive coating 8 separates from the object requiring security.

This eliminates the first color-shift effect, because the interference in the spacer layer, which in the intact security element is composed of the two sublayers 4 and 5, is disrupted. However, the second color-shift effect is retained unaltered.

If an attempt is made to reassemble the assembly, for example by using pressure or by means of an adhesive coating, it is impossible to reinstate the first color-shift effect, because it is impossible to reinstate the original thickness of the spacer layer. Either an air gap remains between the two sublayers or, if an adhesive layer is used between the two sublayers, the thickness of the spacer layer is altered to such an extent that it is no longer possible to reinstate the first color-shift effect, and either an altered color-shift effect is produced or the elimination of the color-shift effect continues.

FIG. 4 depicts an embodiment of the invention analogous to the security element depicted in FIG. 3. However, in the embodiment depicted here the first sublayer 4 of the spacer layer is partial and the second sublayer of the spacer layer covers the entire surface.

In the event of an attempt at tampering, the color-shift effect is disrupted in a manner analogous to that for the embodiment depicted in FIG. 3.

The embodiment of the security element of the invention depicted in FIG. 5 has, in addition to the embodiment depicted in FIG. 3, a partial release-lacquer layer in the form of letters, numerals, signs, symbols, lines, or guilloche patterns or other patterns on the supportive substrate. The release-lacquer layer here is composed of a silicone coating.

The adhesion ratios of the layers have therefore been adjusted in such a way that adhesion of the release coating 10 on the supportive substrate 1 is poorer than that between the two sublayers 4 and 5 of the spacer layer 3.

Where the two sublayers 4 and 5 are present, the assembly exhibits a first color-shift effect from magenta to green, and where only the first sublayer 4, covering the entire surface, is present the assembly exhibits a second color-shift effect from green to blue.

If, after the label has been applied by adhesion, it is subject to tampering, i.e. an attempt is made to peel it from the object requiring security, where the release-lacquer coating 10 is present the release-lacquer coating 10 separates from the supportive substrate 1 or from the cluster layer 2; where the release-lacquer coating is not present the two sublayers 4 and 5 separate from one another. Where the release-lacquer coating 10 is present the first color-shift effect is retained, because no separation of the sublayers 4 and 5 occurs here, and the thickness of the spacer layer 3 thus remains unaltered. The second color-shift effect likewise continues to exist.

Where the release layer 10 is not present, the first color-shift effect is eliminated on separation of the sublayers 4 and 5; the second color-shift effect continues to exist, because in those areas the adhesive coating 8 peels from the object requiring security.

A result dependent on the relative position of the partial release-lacquer coating 10 and of the partial sublayer 5 in relation to one another is the following: if there is overlap between the location of the release-lacquer coating 10 and that of the partial sublayer 5 of the spacer layer 3, the first color-shift effect continues to exist in the overlap regions and after the object requiring security is subject to tampering, whereas in those regions where there is no overlap between the release layer 10 and the partial sublayer 5 of the spacer layer 3 the first color-shift effect is eliminated, because the spacer layer 3 is disrupted. In each case the second color-shift effect continues to exist; where the release-lacquer coating 10 is present, the color-shift effect is visible on the object requiring security, and where the release-lacquer coating 10 is not present the entire layer assembly inclusive of adhesive coating 8 of the remains on the peeled part.

The security element of the invention can be used as security label to provide security to valuable articles, data carriers, objects, or packaging, for example in the pharmaceutical, electronics, and/or food-and-drink industry.

What is claimed is:

1. A security element in particular for security labels, having a supportive substrate (1) which on one surface has an assembly producing a color-shift effect, composed of a layer made of metallic clusters (2), of a spacer layer (3), and of a layer (6) reflecting electromagnetic waves, characterized in that the spacer layer (3) is composed of two sublayers (4, 5) of identical or different composition situated on top of one another, where the first sublayer (4), facing toward the cluster layer (2), has greater adhesion to the cluster layer than to the second sublayer (5), and the second sublayer (5), facing toward the layer (6) reflecting electromagnetic waves, has greater adhesion to the layer (6) reflecting electromagnetic waves than to the first sublayer (4).

2. The security element as claimed in claim 1, characterized in that a partial release-lacquer coating (10) has been applied on the supportive substrate (1) underneath the assembly producing the color-shift effect.

3. The security element as claimed in claim 1 or 2, characterized in that the two sublayers (4, 5) are respectively mutually independently composed of inorganic materials, for example of metal oxides, metal sulfides, metal fluorides, or metal nitrides, or of polymeric materials, for example of cycloolefin copolymers, nitrocellulose, acrylates, methacrylates, polyvinyl chloride, ethylene-acrylate copolymers, styrene acrylates, epoxies, or polyurethanes.

4. The security element as claimed in any of claims 1 to 3, characterized in that the two sublayers (4, 5) have an identical or different refractive index.

5. The security element as claimed in any of claims 1 to 4, characterized in that the two sublayers (4, 5) respectively have layer thicknesses from 10 nm to 2 μm, where the two sublayers can have identical or different thickness.

6. The security element as claimed in any of claims 1 to 5, characterized in that the two sublayers (4, 5) are in essence transparent.

7. The security element as claimed in any of claims 1 to 6, characterized in that at least one of the two sublayers (4, 5) has a coloring or an intrinsic color.

8. The security element as claimed in any of claims 1 to 7, characterized in that the two sublayers (4, 5) cover the entire surface, or at least one sublayer (4, 5) is a partial layer in the form of positive or negative letters, numerals, symbols, signs, lines, or guilloche patterns.

9. The security element as claimed in claim 8, characterized in that prior to tampering the sublayer (4, 5) in the form of positive or negative letters, numerals, symbols, signs, lines, or guilloche patterns brings about a different color-shift effect.

10. The security element as claimed in claim 8, characterized in that after tampering the sublayer (4, 5) in the form of positive or negative letters, numerals, symbols, signs, lines, or guilloche patterns brings about a reduction of coloring.

11. The security element as claimed in any of claims 1 to 10, characterized in that the cluster layer (2) made of metallic clusters is composed of aluminum, gold, palladium, platinum, chromium, silver, copper, nickel, tantalum, titanium, tin, zinc, molybdenum, or alloys of these, for example Au/Pd, Cu/Ni or Cr/Ni, or of colloidal metal clusters.

12. The security element as claimed in any of claims 1 to 11, characterized in that the layer (6) reflecting electromagnetic waves is composed of metals, for example aluminum, gold, chromium, silver, copper, titanium, tin, platinum, nickel, molybdenum, or tantalum, of semiconductors, for example silicon, or of alloys of these, for example nickel/chromium, or copper/aluminum, or of a printing ink with metal pigments, or else of metal oxides, metal sulfides, metal nitrides, or metal fluorides.

13. The security element as claimed in any of claims 1 to 12, characterized in that it comprises other visually discernible and/or machine-readable security features.

14. The security element as claimed in any of claims 1 to 13, characterized in that on that surface of the supportive substrate (1) that is opposite to the color-shift effect a print-compatible primer (9) which accepts a print has been applied.

15. The security element as claimed in any of claims 1 to 14, characterized in that it has a self-adhesive, heat-sealable, or cold-sealable coating.

16. The use of the security element as claimed in any of claims 1 to 15 as or on security labels.
